(19) United States
(12) Patent Application Publication
(10) Pub. No.: US 2013/0055323 A1
(43) Pub. Date: Feb. 28, 2013

(54) METHOD AND SYSTEM FOR CONNECTING A COMPANION DEVICE TO A PRIMARY VIEWING DEVICE

(71) Applicants: Narayanan Venkitaraman, Palatine, IL (US); Matthew B. Cooksey, Chicago, IL (US); Hiren M. Mandalia, Schaumburg, IL (US)

(72) Inventors: Narayanan Venkitaraman, Palatine, IL (US); Matthew B. Cooksey, Chicago, IL (US); Hiren M. Mandalia, Schaumburg, IL (US)

(73) Assignee: GENERAL INSTRUMENT CORPORATION, Horsham, PA (US)

(21) Appl. No.: 13/236,052

(22) Filed: Sep. 19, 2011

Related U.S. Application Data
(60) Provisional application No. 61/529,598, filed on Aug. 31, 2011.

(51) Int. Cl. H04N 21/00

(52) U.S. Cl. 725/82; 725/78

(57) ABSTRACT

A method for enabling communication between a companion device and a primary viewing device includes determining presence of the primary viewing device; and determining presence of the second viewing device. The method further comprises determining that the second viewing device is a companion to the primary viewing device and causes establishment of a viewing group that includes the primary viewing device and the second viewing device. A notification message is provided to the primary viewing device with information enabling the primary viewing device to determine that there is a companion device for it. Additionally, a notification message is provided to the second viewing device with information enabling the second device to determine it is a companion device for the primary viewing device.

### FIELD OF INVENTION

The invention described herein relates to a multimedia environment that can include set-top boxes, cable cards, and other content storage or content facilitator devices in communication with at least one viewing device and a corresponding companion device.

### BACKGROUND

A number of primary viewing devices such as televisions that are enabled with networking capability or access (also conventionally referred to as “Connected TVs”) and displays or monitors that are connected via set-top boxes (STB), commonly provided from third parties, such as cable, satellite, or wireless companies, for example; and gaming consoles can typically communicate with other devices in a home local area network (LAN). In such networks, the primary viewing device may recognize the presence of an authorized second viewing device, for example, a mobile phone, tablet computing device, netbook computer, multi-media device or gaming device within the LAN and may enable the second viewing device to function as a companion to the primary viewing device. Specifically, software may enable a user to use the companion device as a remote control (for example, causing the primary viewing device to change channels). However some primary viewing devices employ a web browser to display media content and include a user interface (UI). The UI can be executed, either via a combination of Hyper Text Markup Language (HTML) or Cascading Style Sheets (CSS) or JavaScript. In these types of primary viewing devices, the UI may also be downloaded from a web server, wherein all communication happens only within a domain of the web server. Consequently, such devices encounter significant communication difficulties to identify and enable a second authorized viewing device to function as a companion device to the primary viewing device. Furthermore, where there may be multiple users in multiple locations that are viewing a single program together as a group, there realistically may be multiple primary viewing devices and multiple secondary devices. In such cases, the primary devices may each be receiving their content from multiple sources Also, there are significant technical difficulties associated with enabling primary viewing devices to recognize a set of other authorized devices that will function as a companion device to the primary viewing device.

Therefore, an improved method and system are needed to reliably connect a companion device to a primary viewing device.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an exemplary pictorial illustration of a communications system comprising multiple networks and multiple audio/visual media content devices in multiple locations.

FIG. 2 is an exemplary flowchart of a method of connecting two or more audio/visual media content devices.

FIG. 3 is an exemplary flowchart of a method of enabling an audio/visual media content device to join an existing viewing group comprised of other audio/visual media content devices.

FIG. 4 shows an exemplary flowchart of a method of communicating between two or more audio/visual media content devices.

FIG. 5 shows another exemplary flowchart 500 of a method of communicating between two or more audio/visual media content devices.

FIG. 6 shows an exemplary flowchart for a method of an audio/visual media content device communicating and/or joining another viewing group other than its own viewing group.

FIG. 7 is an exemplary block diagram of a companion device connector.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A method for enabling communication between a companion device and a primary viewing device includes determining presence of the primary viewing device; and determining presence of a second viewing device. The method further comprises determining that the second viewing device is a companion to the primary viewing device and causes establishment of a viewing group that includes the primary viewing device and the second viewing device, now deemed the companion viewing device to the primary viewing device. A notification message is provided to the primary viewing device with information enabling the primary viewing device to determine that there is a companion device for it. Additionally, a notification message is provided to the second viewing device with information enabling the second device to determine that it is a companion device for the primary viewing device.

Another embodiment includes a viewing group, comprised of the primary viewing device and the second viewing device as at least one companion device, receiving a message, from a third viewing device, indicating intent to join the viewing group. As such, the embodiment determines whether the third viewing device is authorized to join the viewing group. In addition, the embodiment sends a message to at least one device in the viewing group that informs the viewing group about presence of the third device; and also sends a message to the third viewing device with information about the viewing group.

For simplicity sake, the discussion that follows is primarily focused on two audio/visual media content devices. However, it is contemplated that the number of audio/visual media content devices can be in the hundreds or thousands within a large scale system. Additionally, the discussion contemplates connecting multiple viewing devices (i.e., combinations of several primary viewing devices and several companion devices) in multiple locations. The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description. Before describing in detail embodiments that are in accordance with the present invention, it should be observed that the embodiments reside primarily in combinations of method steps and device components related to associating objects in an electronic device. Accordingly, the device components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the method, or device that comprises the element. Also, throughout this specification the term “key” has the broad meaning of any key, button or actuator having a dedicated, variable or programmable function that is actuatable by a user.

Techniques and technologies may be described herein in terms of functional and/or logical block components and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions, and the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

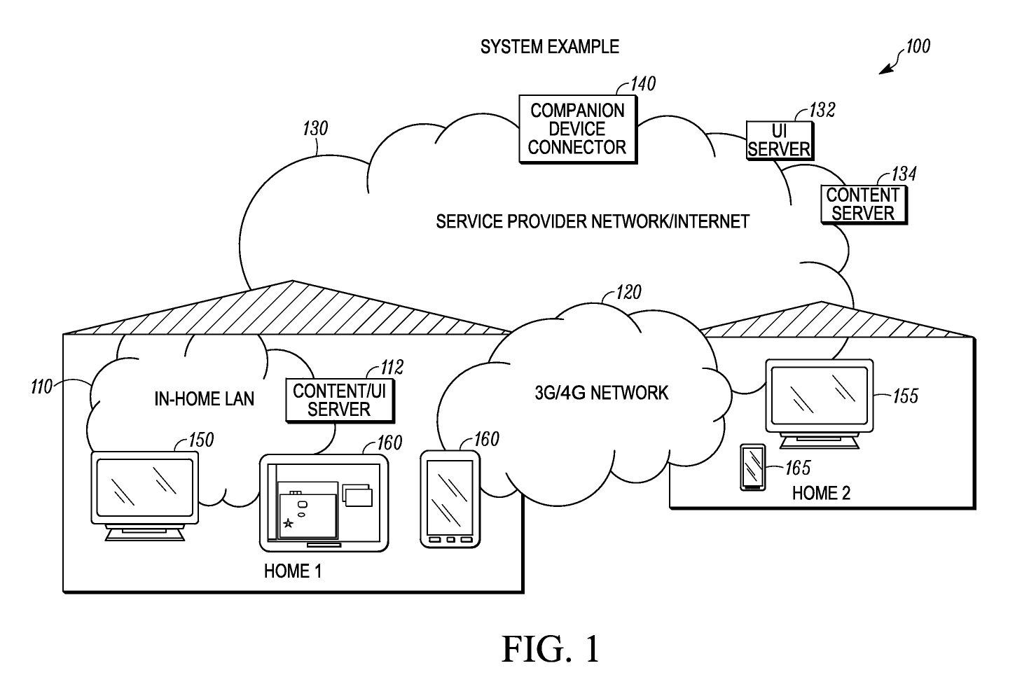

FIG. 1 is an exemplary pictorial illustration of a communications system 100 comprising multiple communication networks (110, 120, 130) and multiple media content devices (150 and 160, 155 and 165) in multiple locations: Home1 and Home 2. A first network 110 at a first location, Home 1, provides in home communication amongst several audio/visual media content devices, for example television or monitor 150 and tablet computer or mobile wireless computing device 160. The first communication network 110 can be an in-home local area network or WiFi network and may comprise a content/user interface server 112 that can be separate, independent components or can be integrated wholly. A second communication network 120 can provide broader and longer distance communication coverage for the several audio/visual media content devices. The second communication network 120 can be a cellular network, for example, 3G, or 4G cellular networks according to 3rd Generation Partnership Project, (3GPP) or a WiMAX network according to the WiMAX forum's telecommunication standards, for example. The second communication network 120 can be a wide area network or WiFi as well.

At a second location, for example Home 2, an audio visual media content pair is depicted. A television or monitor 155 may be connected directly to a third communication network 130 and a mobile computing device 165 may be connected via a wireless network interface, for example, to the second communication network 120. The third communication network 130 within communications system 100 provides broad communication coverage and may encompass the first communication network 110 and the second communication network 120 to provide audio/visual media content and communication messages and protocol information. The third communication network 130 can be a service provider network from a cable company or a wireless communications company, for example. The third communication network 130 can provide Internet service and Internet media related data and content via the World Wide Web or similar means. The third communication network 130 may be a remote server-dominant network comprised of multiple servers linked or networked together, for example a user interface server 132 and a content server 134 that may be integrated wholly or be independent of each other. The third communication network may be an overlay network that utilizes multiple underlying networks and servers to enable inter-device communication.

The first, second, and third communication networks are communicatively coupled together and transmit and receive data and media content between them. A companion device connector 140 is coupled to the third communication network 130. While the companion controller is shown as being coupled to the third communication network 130, in various other embodiments, all or a part of the controller may be coupled to other networks such as 110 and 120. The companion device connector 140 exists to establish companionship between at least two audio/visual media content devices. Companion device connector 140 is also able to distinguish between primary viewing devices and companion devices, for example using a device profile database and determine whether a present audio/visual media content device is a companion device to at least one of the other present audio/visual media content devices within communications system 100. In some embodiments, the companion device connector is able to associate multiple companion devices to a primary viewing device. In some other embodiments, the companion device connector is able to associate multiple primary viewing devices and companion devices, at different networks, together as part of a single viewing set. A primary viewing device such as a high definition television communicatively connected to the first communication network 110, for example, is a first audio/visual media content device 150. Alternatively, the primary viewing device may also be communicatively coupled to a cable-card, for example, or a personal computer, monitor, display surface, tablet computer, smart phone, gaming console or a set top box, capable of streaming media content to the primary viewing device. A possible companion device, the second audio/visual media content device 160 (also referred herein interchangeably as the second viewing device) is communicatively coupled to the second communication network 120. Alternatively, the second viewing device may be coupled to the first communication network 110. The companion device connector 140 determines whether the second audio/visual media content device (e.g., a smart phone or tablet computing device) is actually a companion device to the first audio/visual media content device (e.g., a HDTV or display surface that is communicatively connected to a STB). The companion device connector 140 employs the third communication network (e.g., the Internet) to inform at least one of the first or second audio/visual media content devices about the existence or presence of the newly determined companion device. Additionally, companion device connector 140 may enable these devices to communicate with each other. For example, companion device connector 140 may utilize conventional sticky sessions to enable the primary viewing device to maintain a connection, so that the primary device may receive messages from the companion device. Specifically, companion device connector 140 performs the steps of receiving a message from at least one viewing device in the viewing group; determining other viewing devices in the viewing group, and; transmitting the message to at least a subset of the other viewing devices in the viewing group. Companion device connector 140 may also convert or translate messages received from the companion device from one format (such as XML) to another format (such as JSON), or according to a profile of a recipient viewing device, in general.

In one embodiment, the companion device detector 140 may reside in a single server. In another embodiment, companion device connector 140 may comprise a combination of servers that maintains the device profile and relationship between companion devices and converts message formats, for example, one may employ an XMPP messaging server to enable the companion devices to connect and share presence information, a load balancer with sticky sessions to enable a primary device to maintain connections, and a front-end servlet to provide the UI and enable the primary viewing device to send and receive messages.

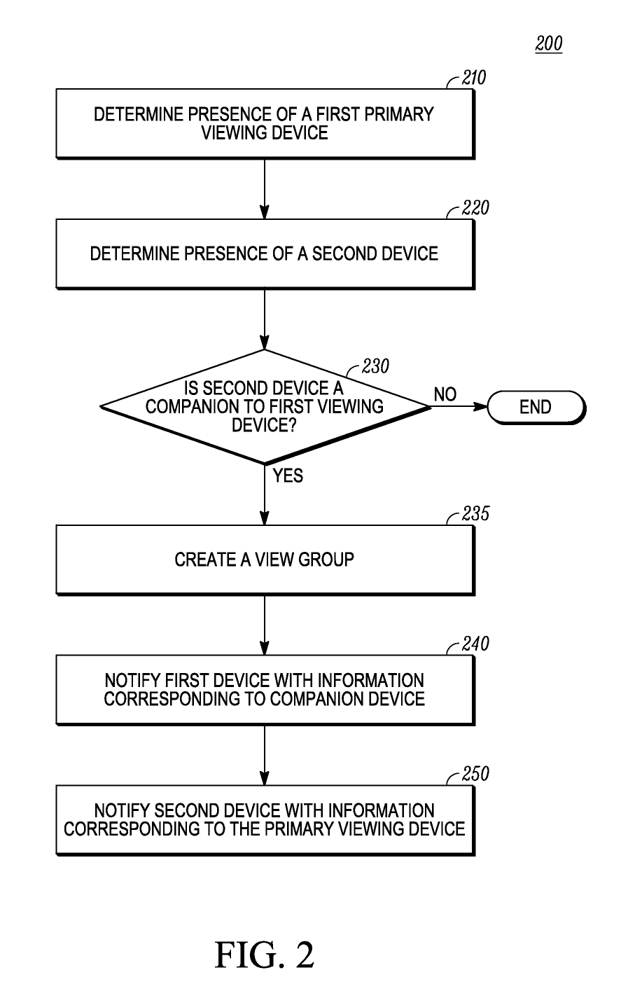

FIG. 2 is an exemplary flowchart 200 of a method of connecting two or more audio/visual media content devices, such as viewing devices, for example. A controller or processor or application server, employing enabling software, can implement the operations of flowchart 200. Operation 210 determines the presence of a primary viewing device. In one embodiment, the determination may be based on a presence message, notification, flag, or indication from a first audio/visual media content device (as shown in FIG. 1). The presence message may include metadata and header information within a message which provides the identity of the viewing device and contact information. In another embodiment, the presence may be determined by querying another device such as a presence server, for example, an XMPP server with the enabling software residing in or communicatively coupled to the XMPP server. In yet another embodiment, another device, for example, a device in the home LAN of the first audio/visual media content device may detect the presence of the first audio/visual media content device, based for instance on a Universal Plug and Play (UPnP) advertisement message and send a presence message or notification on behalf of the first audio/visual media device. Operation 220 determines the presence of a second device. In one embodiment, the determination may be based on a presence message, notification, flag, or indication from a second audio/visual media content device (as shown in FIG. 1). The presence message may include metadata and header information within a message which provides the identity of the device, contact information. Other options or equivalent methods to determine the presence, such as those described for step 210 may also be used. Operation 230 runs an inquiry analysis on data to determine whether, for example, the second audio/visual media content device is a suitable companion to the first audio/visual media content device. As part of 230, the companion device connector may obtain additional data from the companion, or another server, or a database. For example, location information of a viewing device may be obtained by contacting the viewing device or from a location server that has information about the viewing device or both. The location information of the viewing device may comprise viewing device-related data such as assisted global positioning system (AGPS) information, signal strength of WiFi etc. In one embodiment, the analysis may comprise determining that the viewing devices are logged in, using login information that are part of the same account and the current location of the companion device. In another embodiment, the second device may have sent the presence update to the enabling software, on behalf of the first device, upon the second device discovering the presence of the first device.

Should the second viewing device be determined not to be a suitable companion device for the primary viewing device, no further attempts to communicatively link the two viewing devices occur at this time. However, where it has been determined that the second viewing device is a suitable companion device for the primary viewing device, then Operation 235 creates a viewing group (interchangeably termed a “view group” herein) to encompass both the primary viewing device and the now deemed companion device. A view group may comprise an identity of the view group, such as viewgroup1@home1.net. Its membership would comprise of the first and the second devices. The connector may automatically add additional devices to this view group, for example, based on information in the preference database. For instance, when the connector determines the presence of the primary viewing device 150, it may automatically create a view group for home 1, comprising all the devices in home 1.

Operation 240, of flowchart 200, provides information about the newly determined companion device to the first audio/visual media content device. This information can be in the form of metadata. In one embodiment, the notification may be directly sent from the controller or companion connector to the first device. In another embodiment, the notification may be sent to another device, which sent the presence information on behalf of the first device, which in turn may inform the first device. In a similar fashion, Operation 250 provides information about the first audio/visual media content device (also termed, “a primary viewing device”) to the second audio/visual media content device (also termed, “a companion device”). This information can be in the form of metadata. Metadata may comprise information such as identity of the view group and additional information in the form of capabilities of the viewing device: user_name@domain_name/resource_name, IP address, phone numbers etc. Of course, the label designations of the audio/visual media content devices may be reversed dependent on how a user may handle and view the media content displayed or received by a particular audio/media content device.

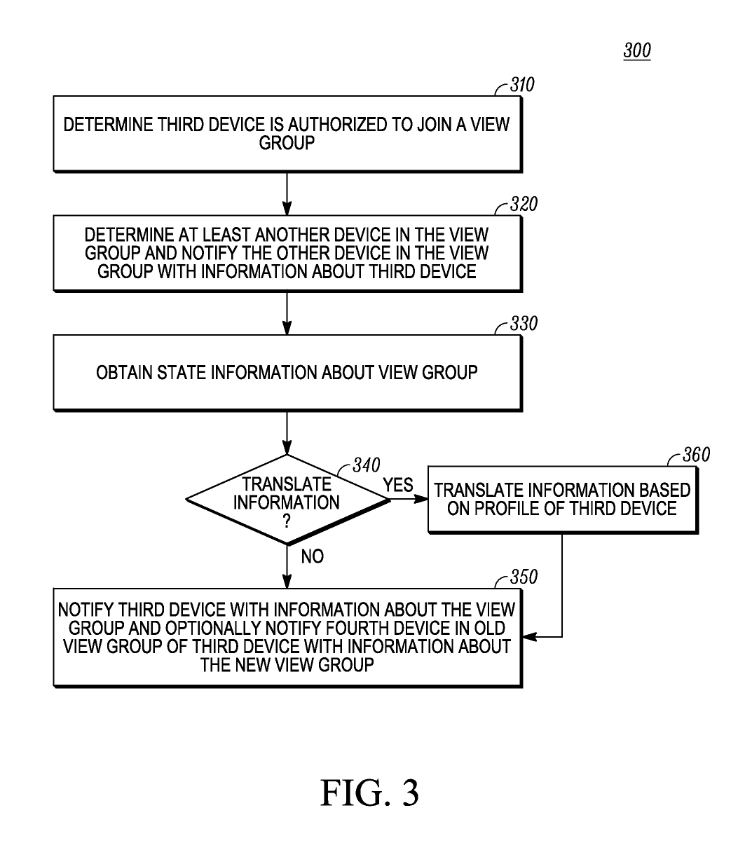

FIG. 3 is an exemplary flowchart 300 of a method of enabling an audio/visual media content device to join an existing viewing group comprised of other audio/visual media content devices. A controller or processor employing enabling software can implement the operations of flowchart 300. The operations in flowchart 300 are focused from the perspective of a companion device connector processing a request from a third audio/visual media content device attempting to communicate with a viewing group comprised of at least two other audio/visual media content devices. Accordingly, Operation 310 determines that whether a third device is authorized to join an existing viewing group of the at least two other audio/visual media content devices. In one instance, the request from the third device may not include view group information. In that instance, based on information comprising identity, location of the third device, the companion connector may determine an existing view group, for example, a view group that is in the same location as the third device or a view group that has other devices that are in the profile of the third device. If more than one view group is found, the companion connector may provide the information to the third device to enable user selection of a view group. In another instance, the request may include view group information such as identity of a view group or identity of another device that is part of another view group. In any case the controller will also determine that the third device is authorized to join the intended view group. In one embodiment this may be based on an authorization profile comprising a list of the device identities that may join a view group including the first device. In another instance, the authorization may comprise sending a message to a viewing device and getting input from the user of the viewing device. For example, when a second companion device in home 1 tries to establishes its presence by providing a request with intent to join a group, the companion controller may first determine the view groups corresponding to home and add the second companion device in home 1 to one of the groups. In another instance, when a companion device in home 2 sends a request with intent to join the view group of a device in home 1, the companion controller first determines the view group of the device in home 1 and authorizes it. Operation 320 determines whether there is at least another device in the viewing group, and if so, notifies the other audio/visual content device in the viewing group with information or data about the presence of the third audio/visual content device. Operation 330 obtains state information about the viewing group. The state information may comprise information about other devices in the group (such as screen size, operating system of devices) and view group information (such as currently watched program channel number, program name or URL of the location of media, state of media, such as live, paused, interactive, etc.).

Operation 340 as shown in FIG. 3, inquires whether the state information about the viewing group needs to be translated for the third audio/visual content device. If no translation is needed, Operation 350 will notify the third device with information about the viewing group and can also, optionally, notify a fourth device, residing in a former viewing group of the third device, with information about the new viewing group of the third device. However, where a translation has been deemed necessary per Operation 340, Operation 360 translates information, sent from either the first or second device, based on profile of the third device. For example, the state information may indicate that view group 1 is currently viewing program under channel number 5. Based on the service provider for the third device, the channel information may need to be translated, based on the local channel lineup associated with the third device, so that the corresponding translated channel number is provided to the third device.

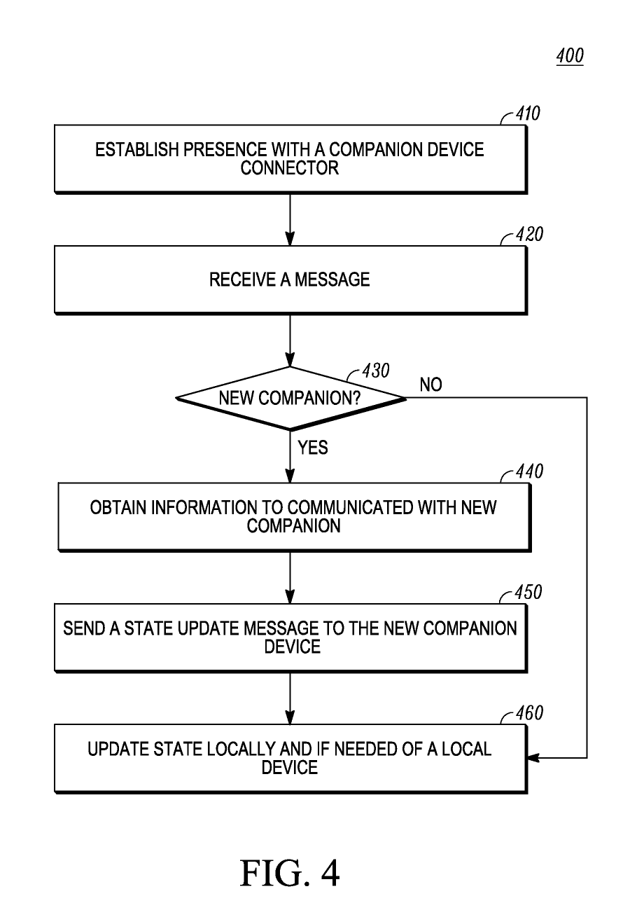

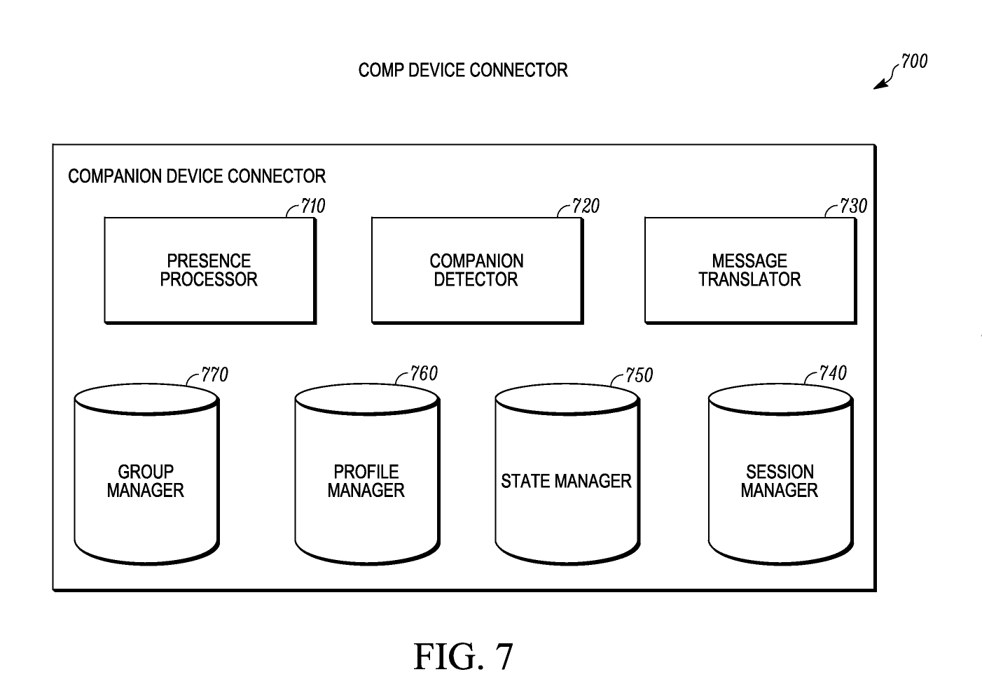

FIG. 4 is an exemplary flowchart 400 of a method of communicating between two or more audio/visual media content devices (as shown in FIG. 1). A controller or processor employing enabling software can implement the operations of flowchart 400. The operations in flowchart 400 are focused from the perspective of the first audio/visual media content device, sometimes herein termed the primary viewing device. For example, Operation 410 establishes the first audio/visual media content device's presence with a companion device connector (shown above in FIG. 1 and subsequently in FIG. 7). In one embodiment, this may be done by logging into a server, such as an XMPP server, that is configured to trigger a presence notification message to the companion controller. In another embodiment, this may be done by sending a UPnP Notify advertisement message in the local network. Upon establishing the presence, Operation 420 receives a message from the companion device connector. For example, after establishing the presence, if there is one or more companion device that the connector has identified, the companion connector would send the message with information about one of the companion devices. The companion connector may also include information about the view group that the primary device is part of; for example, identity of the view group. Information may come directly from the connector or via a proxy device such as a companion device that is in the local network. The message can be in several different formats and can include a header. The message may be formatted by the companion device connector, using Javascript Object Notation (JSON) or Extensible Markup Language (XML) or another format based on the capability of the audio/visual media content device. To enable the companion device connector to send messages, the audio/visual media content device may maintain a connection such as: a http comet connection, web socket connection or TCP connection with the companion device connector.

Operation 430 inquires whether the message provides information about a new companion device for the primary viewing device. If Operation 430 determines that no new companion device is present, then Operation 460 updates state information locally, and if needed also updates state information at a local audio/visual media content device. For example, the message may correspond to a channel change message from another device in the view group. This may in turn result in the primary device updating its state and also announcing that update in the local network. Otherwise, if the message provides information about a new companion device, Operation 440 obtains information to communicate via messages with the newly determined or deemed companion device. The information can include the companion device's profile comprising, for example, owner name, type of companion device, information to send messages to the companion such as a phone number, IP address or universal resource identifier (URI), security key to secure the messages between the devices, format or protocol of companion device, etc. Based on this message the primary device may determine the identity of the companion device user, for example, based on a mapping between device identification such as phone number, media access control (MAC) address and user identification. The mapping may be present locally on the device or on a remote server, such as the companion connector. The primary viewing device may then update its configuration setting such as the kinds of operations that the companion device would be allowed to perform, such as purchase pay per view programs, kinds of channel that the companion device can tune to, administrative settings that the companion device can modify etc., and the kinds of state information that would be transmitted to the companion device etc.

Operation 450, in FIG. 4, enables transmission of a state update message to be sent to the newly determined companion device(s). The state may include information such as the current channel number or the URL of a video being watched. Operation 450 may route the message via the companion device connector. In one exemplary embodiment, the companion device connector may use the identifier of the companion device provided by the companion device connector to enable the companion device connector to route the message to the correct companion device. In another embodiment, the message may be sent directly to the companion device, using, for example, an IP address, port number or URL and security keys corresponding to the companion device.

Additionally, Operation 460 of FIG. 4 subsequently updates state information locally, and if needed also updates state information at a local audio/visual media content device.

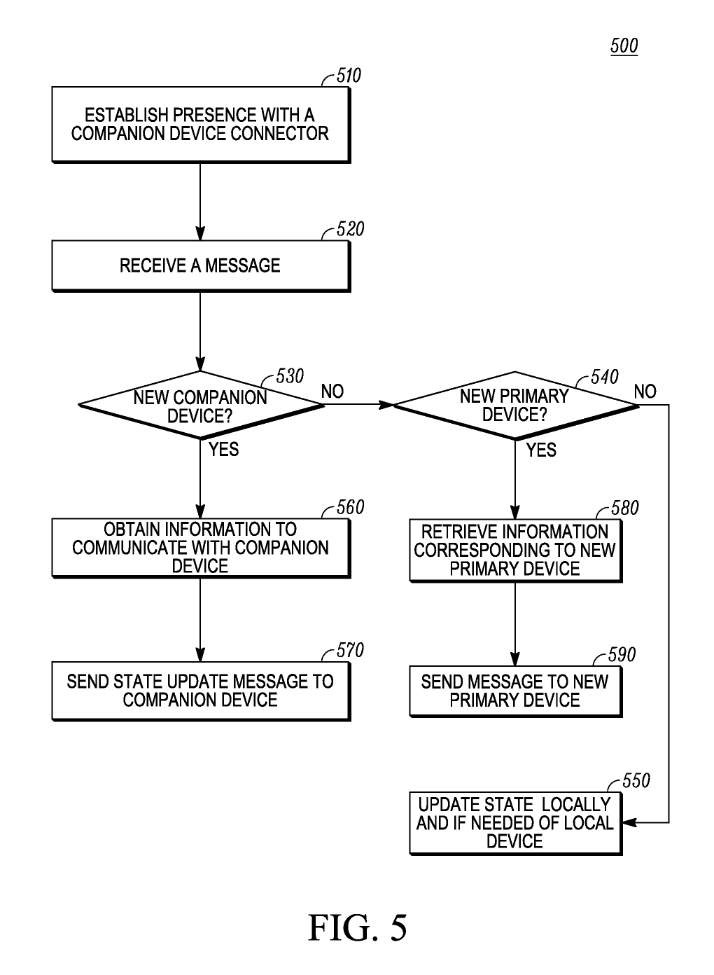

FIG. 5 is another exemplary flowchart 500 of a method of communicating between two or more audio/visual media content devices, (as shown in FIG. 1). A controller or processor employing enabling software can implement the operations of flowchart 500. The operations in flowchart 500 are focused from the perspective of the second audio/visual media content device, sometimes, herein, termed the companion device. For example, Operation 510 enables the second audio/visual media content device to establish its presence with the companion device connector; (shown above in FIG. 1). For instance, the presence may be established by logging into a server, such as a messaging server that is enabled to generate a presence update message to the companion connector. The message may use the same identification (for example, a user@domain/resource) that would be used by the primary device. In one exemplary embodiment, the resource value may be used to identify the type of companion device (i.e., user@domain/mobile1 or user@domain/tablet2) or a different id (usertablet1@domain/res) entirely may be used. Upon establishing the presence, Operation 520 receives a message from the companion device connector (also referred to herein as a companion controller). The message may be a status update from another device in the view group or information from the companion connector/companion controller about a new device in the view group (such as companion or primary device) that has been added to the view group corresponding to the audio/visual media content device. The message can be in several different formats and can include a header. After establishment of presence, the companion device connector uses login information to correlate different primary and companion devices. If there is a primary viewing device that has already logged in, then the companion device connector sends information about the logged in primary viewing device, such as device type and identifier to communicate with the logged in primary viewing device (for example, an IP address/port or security keys), including device capability, its status, and other parameters, for example. In another embodiment, there may be multiple primary viewing devices that are simultaneously displaying a program or other media content, the message may include information about more than one primary viewing device. Similarly, in situations where there are already existing companion devices for one or more of the primary viewing devices, such device-related information may also be provided to the new companion device. Operation 530 inquires whether a new companion device is present. If the inquiry result is negative, that is there is not a new companion device present, a second inquiry is performed by Operation 540. Operation 540 inquires whether a new primary viewing device is present. If the inquiry result is negative, that is there is not a new primary viewing device present, Operation 550 updates state information locally, and if needed also updates state information at a local audio/visual media content device. For example, the message may correspond to action to pause the video. In that case, the companion device may update the local state information to trigger pausing of any video related state updates. For instance, if the video locally is being streamed from a local media server with the TV as a renderer, it may also send an update to the TV and or the media server to pause the video. In another instance, the information may first be translated before updating the state locally. For example, if the message has information about a channel change by another remote device in the group and if the remote device were receiving channel from a different lineup, the channel number information may be translated based on the local lineup prior to the local update, or translation may be based on local profile of the corresponding audio/visual media content device.

If the new companion device inquiry result from Operation 530 is positive, that is a new companion device, for the primary viewing device, is determined to be present, then Operation 560 obtains information to communicate with the companion device. This may include a phone number, URL, IP address or some other form of communication identifier to communicate with the new companion device. The identifier may be that of the companion device itself or a proxy, such as the companion device connector which is enabled to translate and forward messages to the devices in a view group. In addition, Operation 570 sends at least one state update message to the companion device. The obtained information may include information about the identity of at least one primary viewing device, i.e., the first audio/visual media content device. The information can also include the primary viewing device's profile comprising, for example, owner name, type of primary viewing device, format or protocol of primary viewing device, or alternatively the companion device's profile, etc. Alternatively, this information may be generated when there is a state change. Operation 570 enables transmission of a message to be sent to the newly identified companion device. This message may be sent via the companion device connector or directly. A combination of these transmission schemes may be used to communicate with the multiple primary and companion devices that may be part of a viewing group.

If the inquiry result from Operation 540 is positive, that is a new primary viewing device is present, Operation 580 retrieves or obtains information corresponding to the new primary viewing device. The information can include the primary viewing device's profile or state information corresponding to the view group or the primary viewing device, comprising, for example, owner name, type of primary viewing device, format or protocol of primary viewing device, etc. In addition, Operation 590 sends a message to the newly identified primary viewing device. The message may be sent upon discovery to provide an update of the current state of the view group or primary viewing device, or can be sent only when the next state change occurs. This message may be sent via the companion device connector or directly. A combination of these transmission schemes may be used to communicate with the multiple primary and companion devices that may be part of a viewing group.

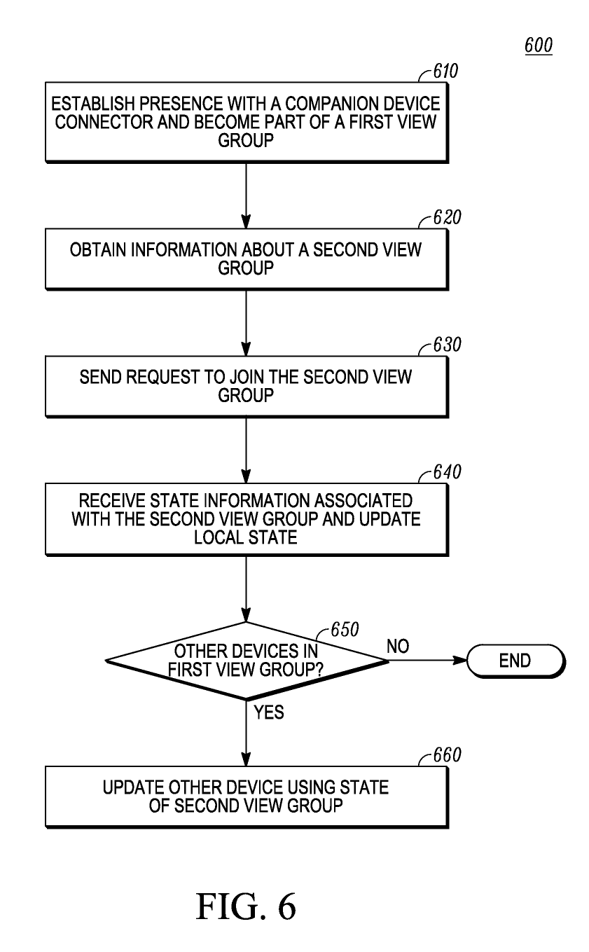

FIG. 6 shows an exemplary flowchart 600 for a method of an audio/visual media content device communicating and/or joining another viewing group other than its own viewing group. Operation 610 establishes an audio/visual media content device's presence with a companion device connector and enables the audio/visual media content device to become part of a first viewing group of audio/visual media content devices. Operation 620 obtains information about a second viewing group of audio visual media content devices. This may be obtained in a number of different ways. In one instance, a companion device may send a request to the companion connector to obtain the view group information corresponding to another device identifier or a user identifier. The companion connector first determines if the request is authorized, and if so provides the necessary information. In another embodiment, a companion device may directly contact another device in a different view group, via email, SMS or another scheme to find the view group information. Operation 630 sends a request to join the second viewing group. The request message may be transmitted to the companion connector which in turn can authorize the request. Alternatively, the request may be sent to a device in the second view group. Operation 640 receives state information associated with the second viewing group and updates local state information either on an audio/visual media content device or on a server communicatively connected to the local audio/visual media content device. The information may comprise security keys to communicate with the group, a view group messaging identifier, for example, a XMPP messaging identifier for the view group.

An inquiry by Operation 650 inquires whether there are other media content devices present in the first viewing group. If there are other media content devices present in the first viewing group, Operation 660 updates the other media content devices using the state of the second viewing group. For instance, in the first view group, there may already be additional devices such as a primary viewing device. If there is a primary viewing device, then a message may be sent to it to update the state of based on the second view group information. For example, if the second view group is watching a different media resource (such as a channel, video URL, etc.), then the primary device can be trigged to tune to that media resource. If there are no other media content devices present in the first viewing group, then the process of flowchart 600 ends.

FIG. 7 is an exemplary block diagram of a companion device connector 700. Notably, the companion device connector 700 may have a set of multiple primary viewing devices and another set of multiple companion devices in a joint viewing group and enable all these content devices to display media content as a group and share device status and device control messages. The companion device connector 700 may also manage multiple view groups. Companion device connector 700 includes a presence processor 710 for analyzing and processing the presence of the first and second audio/visual media content devices. Companion device connector 700 includes a companion detector 720 for detecting the network presence of a companion device for a primary viewing device. The companion detector 720 employs enabling software that correlates a first viewing device's information such as identity of the viewing device, identity of user of the viewing device, user profile, viewing device's location and network presence with the second viewing device.

Additionally, a message translator 730 is a component of the companion device connector 700. Message translator 730 converts formats either of the first audio/visual media content device or the second or third audio/visual media content devices. Message translator 730 may also convert information embedded in the messages based on the profile or context of the receiving device. For example channel numbers may be modified based on lineup of the device. The message translator 730 enables compatibility between at least two media content devices. The companion device connector 700 likewise includes a session manager 740 for managing data transfer between devices in a view group or across multiple view groups. Companion device connector 700 includes a state manager 750 for managing the state of operation of the audio/visual media content devices. For example, the state manager 750 may track the set of primary and secondary devices that have combined to form a single viewing group. State manager 750 may also keep track of additional state information, such as the current program that a view group is watching or presenting for display and the different locations from which the program may be obtained; for example, when a viewing device in home 1 joins a view group corresponding to home 2. Home 1 and home 2 may be different sub networks such that, home 1 may be receiving a video from location 1, which may not be accessible to home 2 and the companion device connector 700 may provide a location that may be accessible to home 2 for the same media. Furthermore, companion device connector 700 may include a profile manager 760 for transmitting and receiving specific profile information about the audio/visual media content device, for example, type of device, owner of device, how long device has been in use, the name of the service provider, etc. Lastly, a group manager 770 may be included for managing one or more viewing groups that the primary viewing devices and corresponding companion devices may be a part of and may be attempting to join via the companion device connector.

In another embodiment, the companion device connector 700 of FIG. 7 can be contemplated as a central cloud service and termed a Companion Service (CS). The CS manages devices, users and their profiles. Based on information (e.g., device presence updates) via a messaging server, the CS recognizes and tracks companion devices (via header properties, for example). The CS may communicate device identification via an asynchronous message to a set-top box's user interface (STB UI). Based on a user ID/resource ID combination included in a received asynchronous message, from an asynchronous notifier, the CS associates a user profile and creates a set of rules and policies for the device.

Subsequently, a companion client logs in to a messaging server/CS. A login profile enables the CS to determine which primary device the companion device/user gets associated with. Based on information (e.g., device presence updates) via a messaging server, the CS recognizes the presence and identification of a corresponding primary device (via header properties, for example).

In sum, the embodiments describe herein provide for a network comprising at least one messaging server, a service in a cluster for a set of primary viewing devices and a set of companion devices. The service itself acts as a network based proxy for managing messaging between primary and companion devices. The service can receive messages from companion and primary devices via a messaging server. The service analyzes and determines that a message likely corresponds to a companion device of a specific primary viewing device. Alternatively, the service analyzes and determines that a message likely corresponds to a primary viewing device of a specific companion device. Messages can be processed based on a profile of the companion device.

The embodiments described herein enable a primary device to have knowledge of its companion devices by employing management of device identification and profiles. As a result, the exchange of messages between companion and primary viewing devices is enhanced and persistent.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Likewise, another embodiment can be implemented as a non-transitory machine readable storage device, having stored thereon a computer program that include a plurality of code sections for accomplishing or performing a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A method for enabling communication between a companion device and a primary viewing device, comprising steps of:
determining presence of a primary viewing device;
determining presence of a second viewing device;
determining that the second viewing device is a companion device to the primary viewing device and establishing a viewing group comprising the primary viewing device and the second viewing device deemed now as the companion device to the primary viewing device;
providing a notification message to the primary viewing device with information for enabling the primary viewing device to determine that there is a companion device; and,
providing a notification message to the second device with information for enabling the second device to determine that it is a companion device to the primary viewing device.

2. The method claimed in claim 1, wherein the notification message to the primary viewing device comprises information that enables the primary viewing device to send messages to the companion device.

3. The method claimed claim 1, wherein the notification message to the second viewing device comprises information that enables the second viewing device to determine the status of the primary viewing device and also comprises additional information for enabling the second viewing device to send messages to the primary viewing device.

4. The method claimed in claim 3, wherein the notification message to the second viewing device comprises an identity of the viewing group.

5. The method claimed in claim 1, further comprising the steps of:
receiving a message, from a third viewing device, indicating an intent to join a viewing group comprising the primary viewing device and the second viewing device as at least one companion device;
determining whether the third viewing device is authorized to join the viewing group;
sending a message to at least one device in the viewing group that informs the viewing group about presence of the third device; and,
sending a message to the third viewing device with information about the viewing group.

6. The method claimed in claim 1, further comprising the steps of:
receiving a message from at least one viewing device in the viewing group;
determining other viewing devices in the viewing group, and;
transmitting the message to at least a subset of the other viewing devices in the viewing group.

7. The method claimed in claim 6, further comprising the step of translating the message according to a profile of a recipient viewing device.

8. A network, comprising:
an application server comprising enabling software;
a first viewing device coupled to the network;
a second viewing device coupled to the network the enabling software;
wherein the enabling software is enabled to determine that the first viewing device is a primary viewing device and the second viewing device is a companion to the first viewing device and enables the first viewing device to determine that there is a companion device present and enables the second viewing device to determine that it is a companion device to the first viewing device.

9. The network according to claim 8, wherein the enabling software enables the first viewing device and the second viewing device to send and receive messages from each other.

10. The network according to claim 8, wherein the enabling software enables a third viewing device to join the first and second viewing devices as another companion device.

11. The network according to claim 10, wherein the second viewing device and the third viewing device are in different sub networks.

12. The network according to claim 8, wherein the enabling software translates information in messages sent from either the first or second viewing device to the third viewing device.

13. The network according to claim 8, wherein the second viewing device discovers presence of the first viewing device and informs the enabling software.

14. A method for establishing a presence of an audio/visual media content device with a companion controller, the method comprising the steps of:
receiving a message from the companion controller;
using information in the message to determine that there is at least a second audio/visual content device within a view group, wherein the second audio/visual content device is associated with a first audio/visual media content device, and;
sending state information about the first audio/visual media content device to the second audio/visual content device.

15. The method of claim 14, wherein the second audio/visual media content device is a companion device to the first audio/visual media content device.

16. The method of claim 15, further comprising the steps of:
using information in the message to determine identity of a companion user, and;
updating local configuration based on the identity of the companion user.

17. The method of claim 14 further comprising the steps of:
using information in the message to determine that there is a primary viewing device associated with the second audio/visual media content device, and;
obtaining state information of the primary viewing device.

18. The method of claim 17 further comprising the step of:
sending a message to the primary viewing device to update state information corresponding to the primary viewing device.

19. The method of claim 16 further comprising the step of:
using information in the message to send state information to another local audio/visual media content device.

20. The method of claim 16 further comprising the step of:
translating information corresponding to either the first or second audio/visual media content device based on local profile of the corresponding audio/visual media content device.
